(19) United States
(12) Patent Application Publication
(10) Pub. No.: US 2019/0135681 A1
(43) Pub. Date: May 9, 2019

(54) Sprayable alumino-silicate coatings, resins, their compositions and products

(71) Applicant: Michael Anthony Jackson, London (GB)

(72) Inventors: Arun Shripad Wagh, Naperville, IL (US); Michael Anthony Jackson, Vancouver (CA)

(73) Assignee: Ceramicoat International Limited, London (GB)

(21) Appl. No.: 15/530,920

(22) Filed: Mar. 24, 2017

Related U.S. Application Data
(60) Provisional application No. 62/390,650, filed on Apr. 6, 2016.

(51) Int. Cl. C03C 8/18; C03C 3/04; C03C 14/00; C03C 4/08; C03C 10/00; C09D 1/00; C09D 5/33; C09D 5/32; C09D 7/12; C09D 5/14; C09D 5/18; C04B 28/00; C04B 14/06; C04B 18/02; B05D 1/02; B05D 7/14; C09D 5/10

(52) U.S. Cl. CPC C03C 8/18; C04B 2111/70; C03C 14/002; C03C 14/004; C03C 4/082; C03C 10/0009; C09D 1/00; C09D 5/004; C09D 5/32; C09D 7/1291; C09D 5/14; C09D 5/18; C04B 28/008; C04B 14/06; C04B 18/02; B05D 1/02; B05D 7/14; C09D 5/103; C03C 2205/00; C03C 2214/02; C03C 2207/04; C03C 2207/06; C03C 2207/08; C03C 3/04

(57) ABSTRACT

Novel formulations of inorganic, chemically bonded, phosphate alumino silicate sprayable coatings are disclosed. The disclosed coatings retain all the positive attributes of similar coatings disclosed in recent patents on corrosion and fire protection, and in addition, provide, superior surface toughness and smoothness, better abrasion and acid resistance, less erosion and longer durability with zero flame-spread coatings on wood surfaces. Being pore-free, water cannot penetrate into these coatings. Unlike the previous inorganic oxide-based phosphate coatings, the glassy phase in these coatings provides a translucent and dense surface. The component pastes are smoother to pump, do not settle or harden during storage and transport, and in addition, do not exhibit pozzalinic properties.

### RELATED U.S. PATENT DOCUMENTS

Provisional Patent Application:

| Application No. | Filing Date | Pat. No. |
|---|---|---|
| 62/390,650 | Apr. 6, 2016 | |

### REFERENCES CITED

1. Chemically Bonded Phosphate Ceramics, by Arun S. Wagh, ed. 2, Elsevier pub. (2016). For details on inorganic oxide coatings, see Chapter 15 of the same book.
2. U.S. Pat. No. 6,569,263, granted to Argonne National Laboratory, issued May 27, 2003.
3. U.S. Pat. No. 8,557,342 B2, granted to Latitude 18, Inc., dated Oct. 15, 2013.
4. U.S. Pat. No. 7,429,290, granted to Thomas Joseph Lally, dated Mar. 20, 2014.
5 U.S. patent application Ser. No. 14/834,409 filed by Latitude 18, Inc. on Aug. 24, 2015

### DESCRIPTION

### Technical Field of Invention

This invention relates generally to a sprayable inorganic phosphate bonded alumino-silicate glass coating and resin material that is used to provide high corrosion resistance to metal, erosion resistance to concrete, protective coating to aluminum, a fire protective coating to wood products and a binder for laminating timber and the methods of production of the invented coating and the method of applying them.

### Background Information

Earlier Art and Practices in Coating: The coating products used in ambient conditions for corrosion and fire protection, as well as those used as decorative paints, are made of polymer emulsions, which form a physical coat over the substrate on which it is applied. They exhibit smooth and pleasing appearance, but also suffer from several inherent problems.
a) They form a physical coat only. If scratched, the scratched surface is exposed and is vulnerable to corrosion. Once this part corrodes, the neighboring coating peels off due to corrosion traveling from the exposed corroded area to underneath the coating. This phenomenon is called osmotic blistering, which is a very common problem with polymer-based coatings.
b) Generally, they cannot be used for fire protection, unless special intumescent (expanding in fire) formulations are used.
c) They release volatile organic compounds (VOCs) during their manufacture, application, and often during early use, thus they damage the low level ozone layer.
d) They produce harmful gases if burn.
e) Their disposal is not safe and hence they need to be disposed according to the local guidelines, which is often expensive.
f) Since they are made of organic compounds, their carbon footprint is high.

Recently, some of these issues were addressed by chemically bonded phosphate ceramic (CBPC) coatings. These inorganic coatings are produced by acid-base reaction between an inorganic oxide and an acidic phosphate-solution. The reference, patent, and patent applications given below teach the materials and methods of producing these CBPC coatings:
1 For chemistry behind the CBPC technology, see, Chemically Bonded Phosphate Ceramics, by Arun S. Wagh, ed. 2, Elsevier pub. (2016). For details on inorganic oxide coatings, see Chapter 15 of the same book.
2 Corrosion protection, D. Brown (LANL) and A. S. Wagh, U.S. Pat. No. 6,569,263 granted to Argonne National Laboratory, issued May 27, 2003.
3 Inorganic Phosphate Corrosion Resistance Coatings, Arun Wagh and Vadym Drozd, U.S. Pat. No. 8,557,342 B2, granted to Latitude 18, Inc., dated Oct. 15, 2013.
4 Fire-retardant coating, method for producing fire-retardant building materials, Thomas Joseph Lally, U.S. Pat. No. 7,429,290, granted to ThomasJoseph Lally, dated Mar. 20, 2014.
5 Fire protection compositions, methods and articles, U.S. patent application Ser. No. 14/834,409 filed by Latitude 18, Inc. filed Aug. 24, 2015.

Unfortunately, their hardness and wear resistance is not good. As a result, they cannot be used in harsh environments and their life span is low. EonCoat, a product resulting from patents assigned to Latitude 18, Inc. recommends its use as a primer only with a polymer coat on the top, which defeats the purpose of use using inorganic materials as environmentally friendly coatings. Use of organic topcoat also makes such products unsuitable for fire protection. The surface of the topcoat is also not hard and cannot withstand impacts or abrasion. The overall cost of using these coatings for passivation purpose only is high, since another topcoat needs to be applied over the passivation layer. In the case of fire protection, the Latitude patent application teaches use of multilayered coats of dissimilar materials, which may not withstand dissimilar heat expansion of individual layers of the coat. Their surface is not smooth and translucent like the polymer coats. Rough surface attracts dirt, makes them UN-washable, barnacles can stick to them in seawater, and hence limits their use. These coatings exhibit slight connected porosity and water absorption. However, considering large exposed surface area of the coatings and long duration of exposure, the atmospheric attack in specialized coatings for applications in chemical environment (in flu gas etc. at high temperature) will be significant and that deteriorates the substrate. Such applications need coatings that are completely impermeable.

These problems arise from the basic drawback in the structure of these coatings. Polymer coats, such as epoxy, work well as abrasion resistant coatings, and their wear resistance is sufficiently high due to their smoothness. This is because polymers are not crystalline structures. They are formed by macro molecular chains, which make them flexible, and also they exhibit smooth surface. On the other hand, phosphate coatings invented in the earlier patents and patent applications exhibit poor abrasion and wear resistance, and their impact resistance is also poor. This is because they are crystalline brittle materials and not polymeric.

The oxide-phosphate coatings disclosed in the earlier patents and patent applications are two component systems, in which one part consists of paste of magnesium oxide or hydroxide. The paste is a pozzalan, i.e., the solid particles settle at the bottom, harden and cannot be remixed during storage and transportation. Segregation of particles and water also hinder flow of the paste in pumps and spray gun, and blocks their flow. They also have a further deficiency in that they create hydrogen bubbles and do not bond with the substrate unless the coating material is heated when sprayed, which is impractical in the field.

Phosphate ceramic coatings provide high corrosion resistance of metals because of the acid-base reaction described in Ref. 1 that is used to form these coatings. It initiates a chemical reaction between the acid-phosphate and the metal substrate on which the coating is applied. This chemical reaction forms a passivation layer on the metal substrate, which is very effective in resisting corrosion.

The fire resistance of the phosphate coatings is very good, as evidenced in the earlier patent application. This is because the phosphate coatings are made of inorganic oxides and oxide minerals, in which there is no carbon to burn. On the other hand, polymers contain sufficient carbon, which burns in fire and combustion of polymer products produce harmful gases.

This implies that an ideal coating, which can retain ability to resist corrosion and fire attacks, and yet exhibit good abrasion and wear resistance, should be produced from inorganic materials, and the product should have a non-crystalline structure like a long chain polymer.

Oxide ceramic coatings disclosed in the earlier patent and patent applications meet these needs, but these coatings consist of mainly crystalline structures. As a result, their flexural properties are not as superior as that of conventional polymer coatings, nor their abrasion resistance. To match the properties of organic polymer coatings, and also to retain the benefits of the inorganic coatings, the coatings should have a polymeric structure and should be produced by using inorganic materials. In other words, they should be inorganic polymers.

Silicates, aluminates and a few phosphates meet this need. In particular, a wide range of silicates and aluminate minerals are known to exhibit glassy structure. Glassy structures (also called amorphous structures) are disordered longer molecular chains, which mimic polymers. Their surface is smooth and the wear resistance is high (granite is a good example). Even common glass has this structure but it is very brittle, because it is not a composite like granite, where glassy structure also embeds particles and makes it a glass-crystalline structure that makes it less brittle. The topcoat of the invented coatings exhibits such glass-crystalline structure.

### SUMMARY OF THE INVENTION

We have disclosed a new chemistry and products in this patent application, which will remedy problems of the current inorganic phosphate coatings including chemically bonded phosphate ceramics, and yet retain the performance benefits of corrosion and fire protection. The alumino-silicate invented coating, when sprayed on metals, especially on iron and steel forms two layers in one single spray, the first layer immediate to the substrate is formed of phospho-silicate-aluminate glassy material, which acts as a corrosion protection passivation layer, and the second layer that of glass-crystalline silicate, aluminate and phosphate products or that of minerals formed by the combination of all three. The invention of a phosphate-bonded glass coating exhibits several inherent advantages, which include,
1. Formation of a chemical passivation layer on steel, which protects the substrate despite any damage to the topcoat. As a result, there is no atmospheric blistering.
2. Exhibit excellent fire protection properties.
3. Contain only inorganic oxide and phosphate materials, and hence do not burn when they come in contact with fire.
4. Because they are formed by chemical reactions between inorganic oxides and acid-phosphates, they do not release any VOCs, and their carbon footprint is low.
5. Being inorganic and non-hazardous in nature, they can be disposed safely in landfill.
6. Due to smoothness of these coatings, they are hydrophobic and easy to wash.
7. The component pastes are smoother to pump, do not settle during storage and transport, and in addition, do not exhibit pozzalinic properties or do not harden during storage.
8. These coatings can be used in place of polymer-based coatings for corrosion and fire protection, heat reflection, for marine coatings applications, and as decorative coatings.
9. The coating material itself may be cast into solid-shapes, or used as an adhesive, and its whisker- and fiber-reinforced composites can be used as thermal resistant, inorganic and yet flexible products for many applications related to high temperature environments, corrosive conditions, and in place of products vulnerable to microbial and bacterial attacks.

### BRIEF DESCRIPTION OF THE DRAWINGS

The appended drawings in Addendum 1 relate to the studies during the development of the material that forms the Invention.

FIG. 1 Compares the structure of the coating claimed in this invention with the existing coatings.

FIG. 2 Depicts a slow-setting formulation comprising phosphoric acid and mixing it with the invented alumino silicate material.

FIG. 3 Depicts the invented coating applied onto hot and cold rolled steel.

FIG. 4 Depicts a coating using KH₂PO₄, instead of using NaH₂PO₄.

FIG. 5 Depicts scanning electron microscopy coupled with energy dispersive analysis on the cross-section of the substrates and the coatings

FIG. 6 Depicts the data from scanning electron microscopy with energy dispersive analysis

FIG. 7. Depicts three stages of salt fog test for 500 hours on exposed samples

FIG. 8 Depicts using the same samples as in FIG. 7 being exposed for another 500 hrs.

FIG. 9 Depicts the microstructure after adding one percent glass whiskers in the silicate materials used to form the coating material

### DETAILED DESCRIPTION OF THE INVENTION

We have disclosed a new chemistry and products in this patent application, which will remedy problems of the current inorganic phosphate coatings and yet retain the performance benefits of corrosion and fire protection. The invented products are a significant improvement over the oxide-phosphate coatings. They can be applied in the same way as the previously disclosed oxide-phosphate coatings. Their curing time will be similar, and the method of washing equipment, disposal methods etc. are the same. The fundamental difference is the chemistry, compositions, and superior performance resulting from the inherent superior properties of the coating materials.

The chemistry utilized in developing these coatings may also be used in producing other products, such as particle- and fiber-reinforced composites, adhesives, quick-setting structural materials products with superior strength.

Silica, silicates, and alumino-silicates are the most abundant and readily available minerals in nature. They are found in both crystalline as well as non-crystalline (or glassy) state. They are very stable in acidic and mild alkaline environment, at high and low temperatures, and in extreme chemical environment. They are primary raw materials needed to produce the invented coatings and other similar products. Their abundance and availability makes them most suitable materials for their production and use anywhere in the world.

Because silicates are insoluble in acidic, neutral, and mild alkaline aqueous environment, they are also not amenable to their synthesis by aqueous acid-base reaction, where solubility is an important factor in acid-base reaction that is crucial to CBPC syntheses. Therefore, the acid-base reaction employed in the earlier inventions and cited in patents listed in the next section, cannot be used to produce silicate-based coatings without additional reaction mechanisms. For this reason, in this invention, we employ a chemical process, which incorporates reduction mechanisms within the acid base reaction that enhance the exothermic heat generation during the reaction, and facilitate the synthesis of chemically bonded phospho-silicate coatings. In other words, introduction of a reduction reaction increases the solubility of silicates and allows one to produce silicate-based coatings by the acid-base-reduction reaction.

Case Study 1

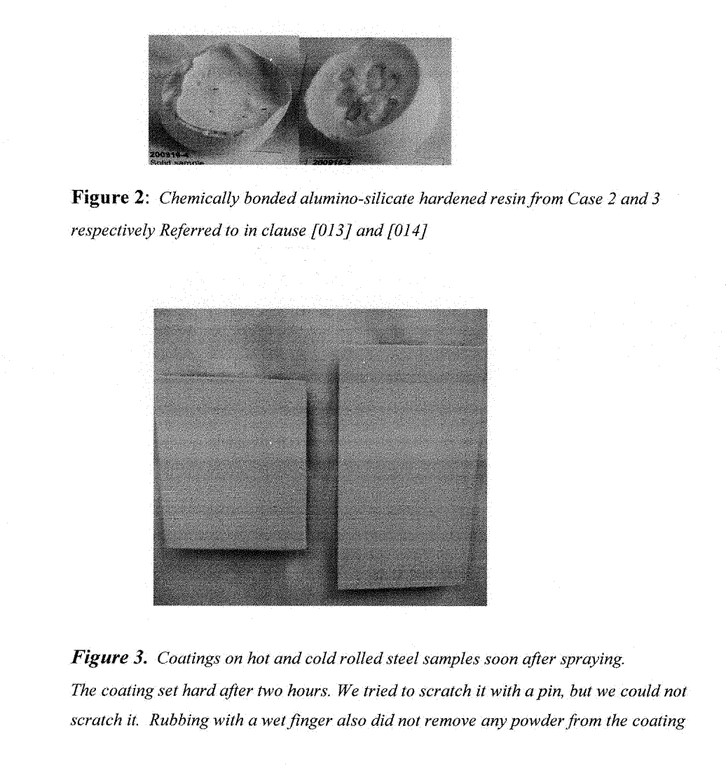

A slow-setting formulation was developed by reducing 50% phosphoric acid solution with 1-5% aluminum by weight in it, and then reacting it with the 75% concentrated aqueous mixture of invented alumino-silicate material in the ratio of 1:2.5 and in another test 1:5. The resulting solids were ivory white, dense, and water impermeable, each hardening in 30 min. The photographs are presented in FIG. 2.

Case Study 2

The same test was done with 67% concentrated phosphoric acid solution, again reduced by 1-5% aluminum by weight. This time the ratio of the acid solution to the aqueous solution of the invented material was mixed with 1:2.5 by weight. The solid samples were cast, which set very rapidly within 5 min.

Case Study 3

In this study, we used an acid-phosphate, NaH₂PO₄. The powder of this acid-phosphate was dissolved in water in the ratio of 1.6:1. The solution was reduced by adding 1-5% aluminum. The reaction was exothermic, but once it cooled, we mixed it with the aqueous paste of 75% concentrated invented material and the solution in the ratio of of 1.8 to 1. Solid samples were made and also steel and aluminum alloy plates were brush-coated (see FIG. 5). Both set rapidly into hard alumino-silicate coatings.

In another similar study with NaH₂PO₄, the powder of this acid-phosphate was dissolved in water in equal amount. The solution was reduced by adding 1-5% aluminum at warm temperature to ensure easy dissolution. We added 8.3% H₃PO₄ solution that was 85% concentrated to produce the acidic paste.

The alkaline paste was prepared by mixing the invented glass mixture, a divalent oxide and a small amount of boric acid (<0.5%). The resulting powder mixture was mixed with 35% water.

A plural spray gun was used to mix the acidic and alkaline paste in a static mixer and panels of hot rolled steel and cold rolled steel were sprayed to a film thickness of approximately 13 mils on hot rolled steel and 22 mils on cold rolled steel plates. The coated hot rolled and cold rolled steel plates are shown in FIG. 3 in Addendum 1.

In another similar test, we used 47.68% NaH₂PO₄ with 4.64% aluminum along with 47.4% water and made paste. To this, we added invented material powder in the ratio 1:1.9. The sample became immediately hard.

Case Study 4

In this study, we used a mixture of an acid phosphate and phosphoric acid. The paste was then mixed with paste formed by mixing a quarter portion of calcined magnesite, two quarters of the invented material, and one quarter of water, which had 1% each of boric acid and glass whisker. Since it is a rapid-setting mixture, we used a plural gun to spray it on steel and aluminum plates in the ratio of 1:2.5. The two components mixed in the static mixer fitted to the gun and the resulting paste was sprayed. The result was a dense thin coating of approximately 12 mils (300 micrometer) thick uniform coating. The coating exhibited a pencil hardness of 10H after one week.

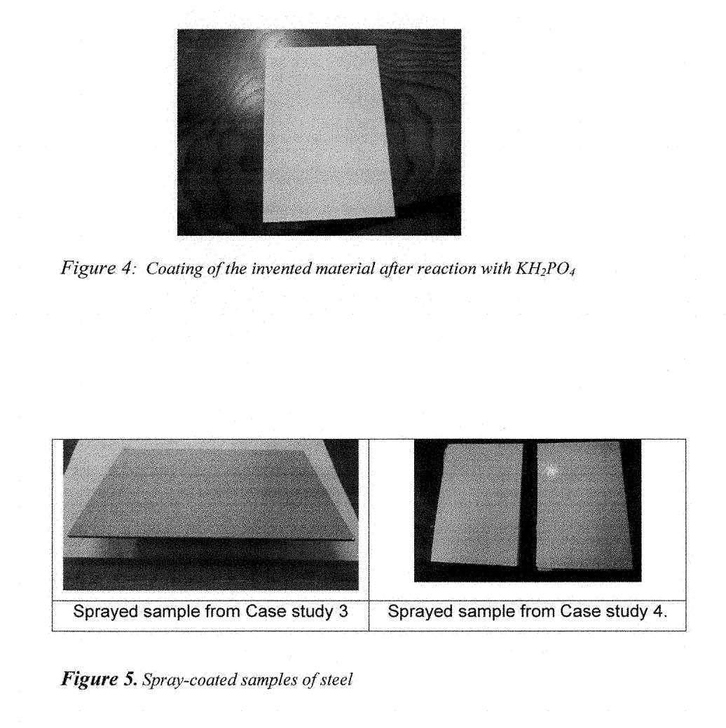

FIG. 4 shows the coating of the invented material on steel in the trial of Case study 4 in Addendum 1.

Case Study 5

The samples produced in the Case studies 3 and 4 were used to study the coating structure. Scanning electron microscopy coupled with energy dispersive analysis was done on the cross-section of the substrates and the coatings. The coated plates are shown in FIG. 5 in Addendum 1.

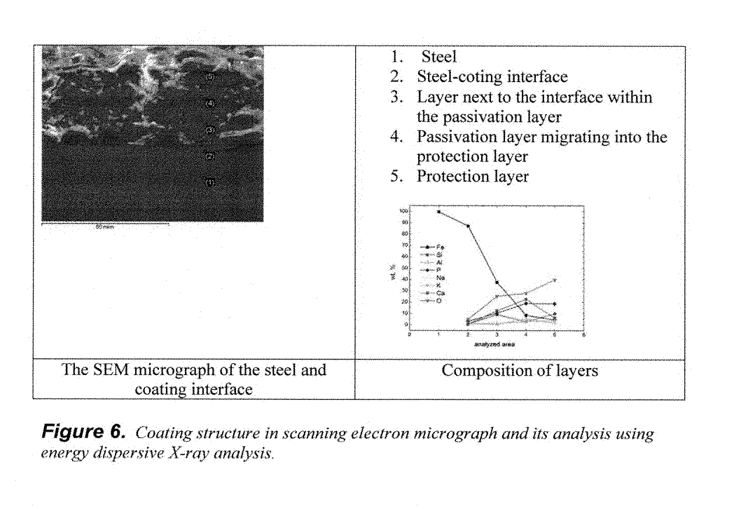

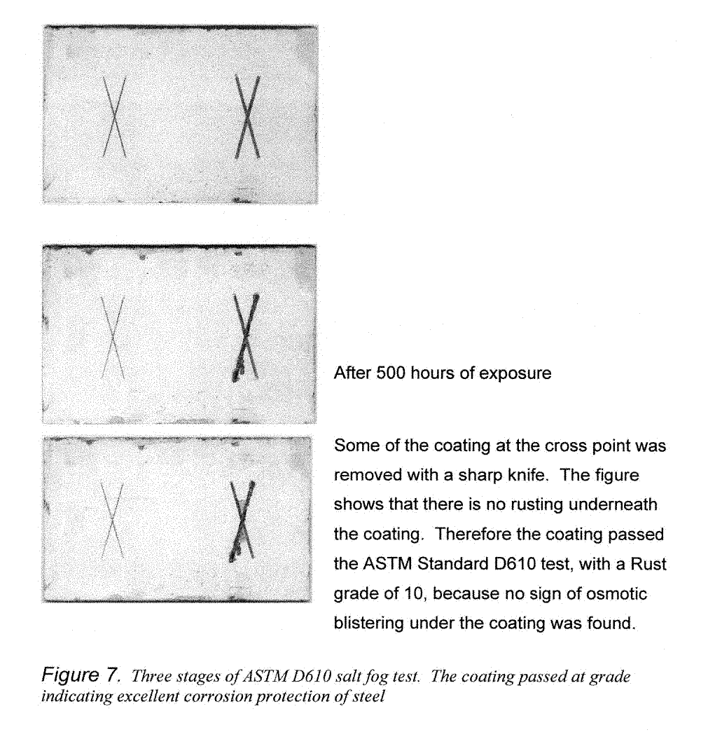

The data from scanning electron microscopy with energy dispersive analysis is shown in FIGS. 6 and 7 in Addendum 1.

The coating in FIG. 5 was applied in one spray campaign at a thickness of 10 mils. It serves the purpose of both passivation and protection coating and no separate application or different coating materials are needed.

The micrograph of the coating in FIG. 5 in Addendum 1. reveals several features of the coating. These are listed below.
a) The coating is dense.
b) The bond between the substrate and the coating is intimate. No gaps seen between them.
c) Iron migrates from the substrate into the coating, and its concentration decreases as one moves away from the interface between the substrate and the coating.
d) Comparative higher content of iron and phosphorous within 30 micrometers (1.2 mils) from the interface (from point 2 to 4) and lower content of aluminum and silicon indicates that the possible compound formed in this region is iron phosphate. Beyond that presence of aluminum and silicon and lower content of iron make the interpretation very difficult.

The migration of iron, which forms the passivation layer deep into the coating makes this coating superior to the phosphate-based oxide coating, which has clear demarcation of the interface between the passivation and protection layers. The coating structure in scanning electron micrograph and its analysis using energy dispersive X-ray analysis is described in FIG. 6 in Addendum 1.

Case Study 6

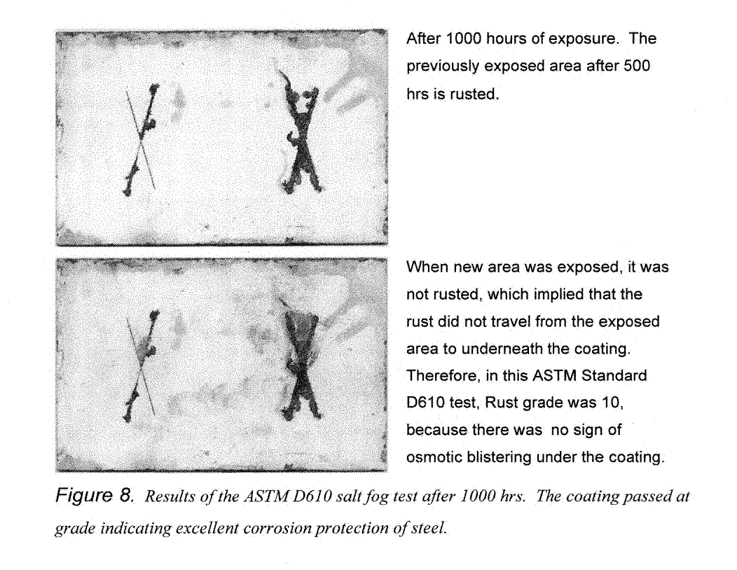

The samples of the coating on steel produced in Case study 4 were exposed to salt fog test as per the test ASTM D610. Before introducing them in the salt fog chamber, two scratches of X-mark were engraved on the plates to remove the coated material as shown in FIG. 8 in Addendum 1. We engraved two scratches one with a thin sharp knife and one with a wider scratch. Photographs of the samples exposed to 500 hours to salt fog chamber are presented in FIG. 7 in Addendum 1. Some of the coating at the cross point was removed with a sharp knife. The figure shows that there is no rusting underneath the coating. Therefore, the coating passed the ASTM Standard D610 test, with a Rust grade of 10, because no sign of osmotic blistering under the coating was found.

These samples were further exposed to salt fog test for another 500 hrs, thus with the total exposure of 1,000 hrs. FIG. 8 in Addendum 1 shows the exposed samples. When the new area was exposed, it was not rusted, which implied that the rust did not travel from the exposed area to underneath the coating. Therefore, in this ASTM Standard D610 test, Rust grade was 10, because there was no sign of osmotic blistering under the coating.

Case Study 7

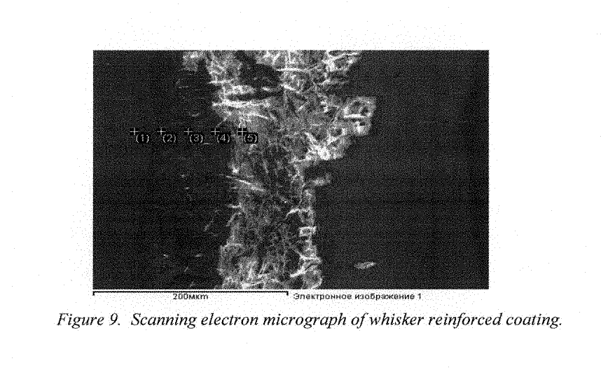

This study was similar to Case study 5, except that we had one percent glass whiskers in the silicate materials used to form the coating material. The result is reinforcement of the coating to provide superior flexural strength. The microstructure of this coating may be seen in FIG. 9 in Addendum 1.

The scanning electron micrograph in FIG. 9 reveals the following.
a) The coating is dense.
b) The bond between the substrate and the passivation layer is intimate.
c) The passivation layer containing FePO₄.2H₂O is ˜25 microns (1 mil).
d) The protection layer is rich in whiskers, while very few whiskers may be seam in the passivation layer. This implies most whiskers are employed in providing high flexural strength of the protective coating where it is needed.

Based on the observations in FIGS. 6 and 7 in the addendum, we may conclude that the coating is bonded intimately to steel, it is pore-free and dense, and the passivation layer is within about 2 mils thick.

In all cases we found that when we try to remove the coating from the surface of steel, we could not dislodge the passivation layer. This means the passivation layer is very hard and bonded well to the substrate, which makes the coating very efficient in corrosion protection.

The glassy structure is produced from silica (SiO₂), alumina (Al₂O₃) or their minerals. In fired ceramics it is produced at high temperatures by vitrifying silica or its minerals. This invention reports production of glass-crystalline coatings by taking advantage of glassy structures of silica, alumina or its minerals (including common glass) and reacting them with an acid-phosphate in ambient conditions. The resulting product is a solid or a film (depending on the method of production) with the desired structure.

The invented coatings are produced by acid-base reaction described in Reference 1. The coatings consist of two pastes, one acidic and the other alkaline. The acidic paste is the activator, which is phosphoric acid, poly phosphoric acid, or an acid phosphate, whose pH is adjusted to activate the alkaline paste. In the invented coating, on the other hand, the alkaline (also can be neutral) side is a composite glass, commonly available in the market, or tailored to our specifications.

### a) Composition of the Individual Components

The acidic component is a solution of acid-phosphate or partially neutralized phosphoric acid. The alkaline component consists of glass formed by one or more of the following inorganic materials.

Silica (SiO₂), calcium oxide (CaO), alumina (Al₂O₃), boron oxide (B₂O₃) and fluorides, and phosphates of sodium, potassium, calcium, and metals added in a small quantity to adjust the reduction potential of individual compounds. To produce standardized quality product, tailored compositions may be manufactured as per the prescribed specifications.

To produce the compositions as per the specifications, the prescribed composition of the mixture of some of these powders is heat treated to a temperature ranging from 1000° C. to 1500° C., and then the heated mass is quenched to room temperature to produce particles with amorphous layers on them. The resulting mass is ground to obtain powder of the right particle size distribution. The resulting powder is sparsely soluble in acidic phosphate pastes, and also can be etched with commonly available etchants. These two mechanisms release a small quantity of these compounds in the acidic solutions of phosphates, and make them reactive and convert them into a phosphate-based alumino-silicate material by acid-based reaction. Large surface area of these particles makes them chemically active when they come in contact with acidic phosphate. An aqueous paste is produced from this powder to mix easily with the phosphate solution for reaction, or the powder may be added directly to the acidic solution to react, depending on the application requirements.

One may also partially mix easily available sources of amorphous silica to augment the performance of these powders. Fumed silica, clean fly ash, are some of these. Fly ash contains silica spheres along with silicate or alumino-silicate amorphous particles. They react readily with acid-phosphates and provide the necessary bond. For this reason, they can be part of the alkaline powder mix.

To keep the powder in suspension, commonly available suspension agents are used.

Since the invented material may be produced as a coating, binder, or as a grout, its applications are numerous.

Coatings produced by the acid-base reaction described in the Section above may be applied using spray guns, brush or rollers to produce thin films on metals, on inorganic surfaces such as cement concrete, and wood. On metal and concrete, they form a chemical bond. The layer formed by this chemical bond is responsible for corrosion protection and is termed as a passivation layer. This layer is protected from external abrasion, impact and other stresses by a protective layer, which is called as the top layer.

Both layers are formed in a single spray, and hence no second coat is needed, unless one intends to build up thickness beyond 250-500 micrometer (10-20 mils) to exploit other properties such as superior insulation, longer chemical protection or esthetic surface formations.

The bond between wood and the coating is only physical. Part of the applied paste is absorbed in wood pores, where it sets and holds the coating on the surface of wood by physical bond; thus the absorbed layer acts like an anchor to the surface coat.

The passivation layer on metals performs an important function of providing corrosion protection to the metal substrate. Especially in the case of steel, where corrosion is a major issue, the passivation layer reacts with iron (Fe) and forms an iron phosphate compound consisting of strengite (FePO₄.2H₂O), which is considered to be very stable corrosion protective compound (See Reference 1, Chapter 15). This will be demonstrated in one of the case studies discussed later. This passivation layer consists of tough phospho-silicate-aluminate glassy minerals, which make the structure of the passivation layer tough, water impermeable, and dense. Therefore, this layer is very stable in a range of chemical environments including saline, acidic, alkaline, marine.

The presence and toughness of the passivation layer distinguishes the coating from other commercial coatings. For example, most polymer emulsion based coatings are simply a physical coat and do not have a passivation layer. Powder coats also do not contribute to corrosion protection other than as physical barriers to the corroding environment. When breached, they all become vulnerable to the environmental degradation of the entire coating by atmospheric blistering. On the other hand, the invented coating, even when the topcoat is breached, does not expose the metal substrate to external exposure, and since the passivation layer itself is very tough and hence cannot be breached easily.

The passivation layers can be formed by applying a primer, such as phosphoric acid, or the oxide-based chemically bonded phosphate ceramics available in the market. However, they all require a second coat that is polymeric, which needs to be applied after the first coat is cured. This necessitates a second round of application. The invented coating is a single spray coating, which produces both the passivation as well as the protective coat. In addition, it gives much tougher passivation layer compared to the oxide-based coatings such as those formed by the reaction of Mg(OH)₂ and KH₂PO₄ [Reference 3].

The topcoat is a pore-free, dense, slightly flexible coating with glass-crystalline structure. It provides protection to the passivation layer from external deterioration mechanisms of impact, abrasion, fire, and chemical and biological attacks.

The properties of the topcoat may be tailored to a desired application. For example, to increase its flexural performance, mineral glass whiskers and fibers may be added to it, which will form a fiber- or whisker reinforced composite that has superior flexural properties.

As an alumino-silicate compound, the topcoat is an insulating material. Being produced from inorganic materials, it is also non-combustible. These are great advantages of the invented materials over polymers for fire protection applications. At high temperatures, polymers not only burn, but also release toxic fumes, while the topcoat in the invented coating is a silico-phosphate mineral, which is stable at high temperatures. No fumes, other than water vapor, are released. By incorporating additional silicate materials and micro spheres either that of silica or silicate glasses, its thermal conductivity can be reduced to ensure that the least amount of heat transfer occurs between the external hot environment to the passivation layer and the substrate. Since the basic composition is silicate-based, added silicate minerals and silica or glass spheres are quite compatible for superior bonding.

Normally reduction in the conductivity is the only mechanism to ensure the least heat transfer in intumescent coatings. In the invented coating, in addition to the advantages described above, the composition may be tailored to produce heat reflective coatings. For example, a coating, rich in heat reflective components, such as rutile (TiO₂) will reflect much of the heat incident on the protective layer and transfer it back to the environment, even before its transfer is reduced by the poor conductivity of the coating. If the coating is used to conserve heat by applying it to containers with hot material (such as boilers, steam pipes etc.), it will reflect the heat back into the containers and the radiative heat transfer to the environment is reduced. Thus, the invented coating is non-combustible, and exhibits low thermal conductivity and heat reflection. These three attributes make this material unique for fire protection and heat conservation applications, such as coatings needed for oil pipelines, where hot crude is transported over long distances, or metal pipes used for transport of superheated steam from power generators to industries located at a distance.

The invented coatings are very stable in an acidic environment, mainly because they are made of silicates. Silicates are stable at very low pH, as low as 2. Therefore, silico-phosphate coatings provide excellent stability to chemical environment and saline conditions.

The pore-free and smooth topcoat is ideal for applications in hot and humid tropical environment, where growth of algae and fungus is common, or in marine environment, where barnacle attachment and other microbial and bacterial growth is a major issue. Because the surface of the invented coating is pore-free, barnacles cannot attach themselves to the coated surface, or microbes cannot find pores which fosters their growth.

### a) Method of Application of the Coatings

The invented coating is applied by mixing the acidic and alkaline pastes, so that the chemical reaction is initiated. This is done by using a plural pump system, in which two separate pumps force the acidic and alkaline (or neutral) pastes into a static mixer, which mixes the two components and an acid-base reaction is initiated in the mixed paste. The reacting paste is sprayed under pressure on the substrate desired. The method mimics that of a two-part epoxy system and hence similar PLURAL pumping system can be used.

### b) Chemistry of the Coatings

The coating product is formed when the mixture of the compounds is activated by the acidic medium of the phosphates.

When the Part A and Part B are mixed, they react and form silicate, aluminate, and alumino-silicate mineral complexes that are partially in glassy phases. These structures are very similar to many of the natural phosphate minerals, such as apatite and man-made glass ceramics. The difference, however, is that nature produces these minerals at high temperature without using water, while this invention discloses a mineral formed at room temperature in an aqueous medium by acid-base reaction of these minerals with phosphates.

The coating structure also differs significantly from conventional polymer coatings.

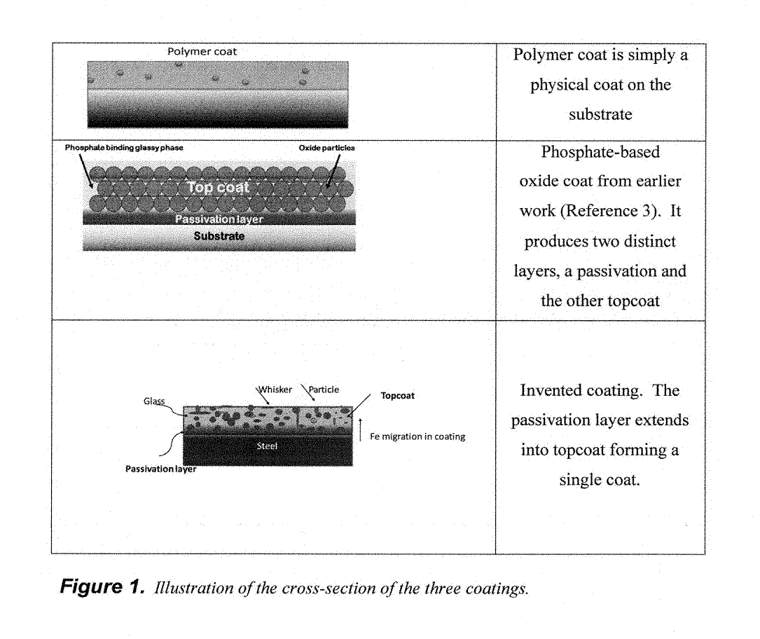

The difference between the polymer coating, oxide based phosphate coating, and the invented coating may be seen in the illustration in FIG. 1 in Addendum 1 Conventional polymer coatings do not have a passivation layer and hence exhibit poor corrosion protection. Compositions and products of earlier phosphate-based oxide coating produce the passivation layer but are crystalline and vulnerable to abrasion and impact. The invented coating has the benefit of both. The passivation layer has a continuous glassy structure that extends into the topcoat forming a single coat.

### d) Enhancement of Desired Properties of the Coatings

Depending on the application, one may tailor the formulation with various additives in the invented coating either to the acidic side or to the basic side or both. Following are some examples.

d-1) Flexural Strength

Flexural strength is enhanced by adding fine whiskers of glass or minerals, such as wollastonite (CaSiO₃). One can add cellulosic fibers also if these coatings are not designed for high temperature applications. Some of these additives will react sparsely with the acid phosphate and form their own bond, and some will be totally unreactive. Either way they enhance the flexural strength and elastic modulus of the coating.

d-2) Enhancing Toughness of the Coating

Toughness of the coating is enhanced by introducing hard particles and particles in platelet structures, such as fine-grained sand or kaolinite, which is in platelet form, in the silicate mixture. Other additives are clay, calcined alumina (Al₂O₃), titanium dioxide (TiO₂), zirconia (ZrO₂) etc. Inclusion of any particles that are unreactive in the acid-base reaction and exhibit extreme hardness will serve the purpose.

d-3) Enhancing the Heat Reflectivity or Absorption

For heat related applications, heat reflecting minerals, such as rutile or magnesia are added in the silicate mixture. These minerals have very high heat reflectivity (90%-99.9%) and they enhance the heat reflectivity of the coatings, which helps to keep the substrate cooler.

In place of heat reflectivity, if more heat transfer is needed through the coating, one may add heat absorptive minerals in the powders of the pastes claimed in Claim 3 or 5. The heat absorptive minerals include, but not limited to, black iron oxide (magnetite, Fe₃O₄), wustite (FeO), lamp black (carbon), and manganese oxides (MnO, Mn₃O₄).

Adding such minerals in paints is not something new. They have been added in commercial polymeric paints, such as Mascot, Rust-Oleum etc. However, the invented coating, being all inorganic, high loading (as much as 10 wt. %) can be achieved without the loss of other favorable properties, and as much as 25% if the additives themselves are reactive with phosphates. Examples of such reactive additives are MgO, FeO, Fe₃O₄, and Mn₃O₄ that were stated in paragraphs [045] and [046].

Another feature that makes this coating unique is that the invented coatings are stable at high temperatures, even up to 900 C. Heat reflective, in combination with the thermal stability, makes these coatings useful in unique applications such as interior of furnaces, high pressure steam pipes, hot fluid transport pipes etc., where polymeric paints cannot be used.

d-4) Anti-Fungal Formulations

A very small amount of copper oxide or any other anti-bacterial compound may be added to the silicate powder to produce coatings with anti-fungal surface, which will also reduce algae growth on the coating. In particular, this coating will be ideal as marine coating. With its inherent smooth and pore-free surface, it is difficult for barnacles to grow on it, and at the same time, due to the presence of copper or other anti-bacterial compounds, fungal or algal growth will not occur.

d-5) Pigmented Coating

The invented coatings are white or beige in color. For architectural applications, they can be produced in different colors by adding suitable oxide- or silicate-based pigments. Using these, a whole spectrum of colors with different shades can be produced.

The coating materials disclosed in this patent application have numerous applications, because they can also be produced in solid forms. They are quick-setting binders, which are mixed with various aggregates and fillers and tailored to suitable applications. Following are some of the major applications (but not limited to) of the invented material produced by the acid-base reactions.

a) Rapid-Setting Grouts

The invented material may be used to produce rapid-setting grout and concrete. Adding the binder to sand, gravel, any type of aggregates, waste materials such as fly ash, bottom ash, construction industry solid waste, solid mine tailings, byproduct waste streams such as leached out red mud from alumina industry in large proportions etc. at a loading of 15% to 60% will produce rapid-setting grout that can be used as concrete, injectable sealers for civil engineering applications, or as construction materials. Due to the dense structure of the binder material, the resulting products can be made water impermeable. Because of the durability of the binder in high temperature, the resulting product will also be of refractory nature. Most waste streams contain silica and alumina and the compatibility of silicate-based invented material is chemically compatible with the binder for most of these applications.

b) Fiber and Whisker Reinforced Composites

Fiber reinforced composites used to produce various commercially and domestically applicable products such as noncorrosive polymer pipes, casings to hold small products such as electronic components to appliances, automobile parts such as fenders, body parts etc., even components useful in aeronautical industry, wind mills, toys and bins and buckets that are used in everyday life are all produced by reinforcing polymer matrix with glass, carbon, and cellulosic fibers.

The common feature of all these products is that they contain large volume of fibers or whiskers that are held together by a polymer binder such as epoxy, polyethylene or polypropylene. They are lightweight products, do not absorb moisture and their surface is hydrophobic. The drawback, however, is that all of these products are also heat sensitive and cannot withstand high temperatures, some of them not even >150 F. They also burn releasing harmful gases.

Composites, similar to those described above may be produced by using the invented binder as the adhesive that will replace the polymers. The invented adhesive is inorganic and hence does not burn. In fact, its heat reflectivity can be an advantage in the event of extreme radiative heat or fire. Therefore, they are ideal materials for production of inorganic polymer composites.

c) Inks for 3-D Printing

The adhesives disclosed in this invention are rapid-setting binders. Using the two-component system described above, they can be used in 3-D printers to produce intricate alumino silicate products. The current products are made with mostly polymers and hence are vulnerable to heat.

The resulting product may be heat treated to produce a phospho-alumino-silicate object with additional strength. Thus using the binder invented in this disclosure may produce intricate designer products.

We claim the following:

1. A two-part aqueous sprayable system of a reactive mixture of an acidic paste and an inorganic neutral or alkaline powdered glass that are mixed to form alumino-silicate coatings, resins and solids.

2. In the coating system in claim 1, the acid-phosphate in chemically reduced form, containing phosphoric acid or an acid-phosphate, or their mixture, and the alkaline part is alumino-silicate or alumino-silicate halide glass that can be modified using various additives.

3. The alumino-silicate or alumino-silicate halide glass in claim 2. shall consist of silica (SiO₂), or a silicate of any element, including but not limited to, alkali metal silicates, such as but not limited to, sodium and/or potassium silicates, silicates of sparsely soluble metals such as magnesium, zinc, calcium, trivalent metals such as, but not limited to, aluminum, boron, iron, and manganese and shall be in glassy or amorphous form, which includes, but not limited to, alkali metal glasses, alumino-silicate glasses, fluoride glasses, or any combination thereof.

4. (canceled)

5. The acid phosphate claimed in claim 1 shall consist of diluted phosphoric acid, or a dihydrogen phosphate of an alkali metal, such as but not limited to, sodium, potassium or cesium and/or ammonium ions. It may also contain one or more reductants, such as a metal, including but not limited to, magnesium, calcium, zinc, aluminum, iron, and manganese.

6. (canceled)

7. The rate of acid-base reaction described in claim 1 may be enhanced by adding oxides of divalent or trivalent metals, such as oxides of calcium, zinc, barium, iron, magnesium, manganese, and four-valent metal zirconium. They may be added in the alkaline paste claimed in claim 1 at 1-30% of the total paste in general, preferably between 5-25% and most preferably between 20-25% by weight of the total paste.

8. Additional additives either in acidic or alkaline parts of the system in claim 1 are flexural strength and enhancers, including but not limited to, unreactive fibers or whiskers, such as those made of but not limited to, natural fibers and/or mineral whiskers, any glass, polymer, and rheology modifiers, such as but not limited to xanthan gum, kaolinite, retarders such as boric acid and commercial suspension agents and dispersion agents, density enhancers such as but not limited to any heavy minerals including quartz, barium oxide, lanthanide oxides (lanthanum or cerium oxide), zirconium oxide etc. These are added at 0.5 to 5 wt. % of the alkaline paste.

9. For good aesthetic appearance, in applications such as architectural coatings, we claim addition of any compatible pigments including, but not limited to, ceramic or mineral pigments, in either the acidic or in alkaline part of the system in claim 1, and to further improve the texture of the coating, we claim addition of hard and coarser mineral powders, and mineral platelet structures in either acidic part or in basic part of claim 1. These include but not limited to, kaolinite, mica, and any other mineral with platelet microstructure. These are again added at 0.5-5 wt. %.

10. (canceled)

11. To improve the optical or heat reflectivity of the coating, we claim addition of glassy silicate and aluminates, or alumino-silicate materials, certain heat reflective minerals, such as but not limited to, periclase crystalline magnesium oxide, rutile, and for heat absorption, natural minerals or man-made products such as, but not limited to, black iron oxide (magnetite), and lamp black carbon, or graphite. The heat reflective or absorptive additives may be blended into the silicate materials at a loading of 1-10% by weight that have ability to reflect most of the heat radiation (infra-red radiation) or absorb heat thereby reducing or increasing heat transfer through the coating.

12. The proportion of aqueous acidic and alkaline pastes in claim 1 shall be in volume proportions of the acidic and alkaline pastes between 1:1 and 1:9 in general and preferably 1:2 to 1:9 and mostly between 1:2 to 1:8.

13. The water content in the acidic part of the system in claim 1 shall be between 15% to 70% of the total acid paste by weight, preferably 30% to 55% and more preferably 30% to 55%, while the water content of the alkaline component of the system in claim 1 shall be between 0% to 50%, but preferably 0% to 40% and more preferably between 0% to 25% by weight of total alkaline component.

14. (canceled)

15. The pastes claimed in claim 1 include 1-2% fluidity modifiers and suspension agents for storage and transport of the pastes during use. These will include, commercial dispersion agents and rheology modifiers.

16. The resulting pastes claimed in claim 1 and described in claims 2, 3, 5, 7, 8, 9, 12, 13 are mixed by mechanical means or using static mixers of a spray pump at the time of use, and the mixed paste is then sprayed, extruded, brushed, applied using rollers, or dispensed by commonly known methods. We claim the resulting hardened product, which may be a coating, a cast form, or porous ceramic, all of which are formed by the reaction between the acidic and alkaline pastes claimed in claim 1 and whose compositions are claimed in claims 2 3, 5, 7 to 10, 12 and 13.

17. The coating claimed in claim 16 when sprayed on metals, especially on iron and steel, alloys of copper, nickel, chromium forms two layers in one single spray, the first layer immediate to the substrate is formed of phospho-silicate-aluminate glassy material, which acts as a corrosion protection passivation layer, and the second layer that of glass-crystalline silicate, aluminate and phosphate products or that of minerals formed by the combination of all three. We claim these silicate-based layers formed on metals.

18. The coatings claimed in claims 16 and 17 are capable of corrosion protection of metals, such as but not limited to, all kinds of iron products including cast iron, mild steel, and carbon steel, and aluminum, nickel, chromium and its alloys. We claim these coatings.

19. We claim the heat reflective or absorptive phospho-silicate coating formed by addition of the heat reflective or absorptive materials claimed in claim 11 in the product resulting from the system claimed in claim 1. We claim the resulting compositions and their application as fire protective coatings. We also claim the composites where these alumino-silicate modified resins are used and also the hardened resins used as solid objects.

20. (canceled)

21. (canceled)

22. The additive oxides claimed in claims 7 and 8 can be reactive and form part of the unique glass-crystalline structure of the coating. We claim the resulting product of these reactions.

23. (canceled)

24. We claim addition of bacterial and microbial growth inhibiting commercial additives such as copper based algae preventers or any other antibacterial and anti-microbial inhibitors in either acidic or basic pastes claimed in claims 1, 3, 5 12, 16. We claim the resulting algae and microbial resistant coating produced by the processes claimed in claims 1, 12 and 16.

25. The extruded mixed paste of the two pastes claimed in claim 16 and 17 or mixed by commonly available methods and means that can be used as an adhesive, or grout when mixed with unreactive hard powders such as but not limited to sand, or gravel to form phosphate concrete. We claim all these products.

26. The extruded mixed paste that sets rapidly may be used for production of designed ceramic forms using 3-D printers, or by simple extrusion. The resulting set form is a glass-ceramic. We claim the resulting products and methods of their production.

27. The resulting products claimed in claims 17-19 and 25 or sprayed as a coating claimed in claims 16 and 17 may be heat treated to improve their strength by heating them in kilns at temperatures ranging from 700° C. to 1500° C. The latter may also be used as high temperature coatings to provide corrosion and fire protection as well as heat insulation by heating the substrate. The resulting products are glass-ceramic in nature and we claim all products produced by using the system claimed in claim 1, and pastes claimed in claims 1, 2, 3 and 5.

28. The pastes resulting from the addition of whiskers and fibers claimed in claim 8 in pastes claimed in claim 1 form whisker and fiber reinforced composites. We claim all products produced by the system claimed in claim 1 and produced by the method described in claim 16. The amount of loading of fibers may be anywhere from 1 wt. %-92 wt. %, which is used to simply improve the flexural property of the silicate-bonded matrix to produce fiber reinforced composite, in which the silicate bonded matrix is used as an adhesive.

29. The extruded mixed paste produced by the method claimed in claim 16 may be injected between the fibers as claimed in claims 6 and 26 stacked together either by simple injection method, or by vacuum suction of the paste through the stack of fibers to pass through between the fibers, or by wetting the fibers first with the paste and then stacking them either under pressure or without it and produce fiber reinforced composites. We claim the resulting composite products produced by the pastes claimed in claim 1 and with the additives claimed in claims 7 to 11 and proportions claimed in claims 11 and 12, and applied by methods claimed in claim 16.

30. (canceled)

31. The heat reflective resins and coatings claimed in claims 11 and 19 may be used to coat wood panels, wood composites and produce non flammable wood products. They may also be used to produce wood-fiber-reinforced composites claimed in claim 29. These products exhibit, zero flame spread, and also very high resistance to flammability. We claim all such wood-composites, and heat resistant coatings for wood products.
